(19) United States
(12) Patent Application Publication
(10) Pub. No.: US 2013/0342643 A1
(43) Pub. Date: Dec. 26, 2013

(54) Scalable System and Method of Providing Stereoscopic Video in a Requested Format

(71) Applicants: Karlheinz Gelhardt, Birkenau (DE); Andreas Baumgart, Birkenau (DE); Vincent Heuveline, Blankeloch-Stutensee (DE); Maximilian Hoecker, Ludwigshafen (DE); Marcel Kunze, Pfinzial (DE); Sebastian Ritterbusch, Karlsruhe (DE)

(72) Inventors: Karlheinz Gelhardt, Birkenau (DE); Andreas Baumgart, Birkenau (DE); Vincent Heuveline, Blankeloch-Stutensee (DE); Maximilian Hoecker, Ludwigshafen (DE); Marcel Kunze, Pfinzial (DE); Sebastian Ritterbusch, Karlsruhe (DE)

(21) Appl. No.: 13/528,431

(22) Filed: Jun. 20, 2012

(51) Int. Cl. H04N 13/00

(52) U.S. Cl. 348/43; 348/E13.068

(57) ABSTRACT

Various systems and methods for providing stereoscopic video in the format requested by a user to a recipient are provided. A variable number of users and recipients can be accommodated by dynamically determining the computing resources to utilize in providing requested stereoscopic video. Providing stereoscopic video in the format requested by a user allows for accommodating multiple types of stereoscopic video equipment.

### BACKGROUND OF THE INVENTION

Standard video presentations display information in two dimensions, which means that the left and right eye see the exact same image. However, actual human vision relies on each eye seeing a slightly different image which allows us to perceive perspective (i.e., distance of objects). This is referred to as stereoscopic vision. Stereoscopic video presentations present each eye with a slightly different image to provide the same sense of perspective that is obtained when observing real world objects. Because stereoscopic video represents viewing in three dimensions, stereoscopic video is commonly referred to as 3D video.

Various techniques have been employed to provide stereoscopic video. Some examples of stereoscopic video techniques are Anaglyph 3D, polarization 3D, Active Shutter, and Side-by-Side. Each technology has its own advantages and limitations. In fact the existence of the various stereoscopic video technologies presents its own problem. Systems must be designed with one particular stereoscopic system in mind. This limits the ability to widely distribute stereoscopic video presentations because all viewers are required to have the same viewing equipment.

The disclosed technology is not limited to a particular type of stereoscopic format, but as background some of the known formats are described below:

### Anaglyph 3D

This method of presenting stereoscopic video content relies on placing a filter of a different color in front of each eye. One common configuration uses glasses comprising a red filter and a cyan filter. The 3D video presentation contains images using black, white, red and cyan. The eye utilizing a red filter perceives any red portions of an image as white and cyan portions as black. Similarly, the eye utilizing a cyan filter perceives any cyan portions of an image as white and red portions as black. Portions that are actually black or white appear normally. Via the appropriate use of red and cyan, each eye will perceive slightly different images producing a stereoscopic effect. In the absence of the appropriate glasses, images will appear to have red and/or cyan shadows.

### Polarization 3D

This method of presenting stereoscopic video content relies on presenting images of orthogonal polarity. The viewer utilizes a pair of glasses with a polarizing filter for each eye. The polarizing filters for each eye are arranged orthogonally such that light polarized for one eye cannot be perceived by the other eye. By simultaneously (or in rapid succession) displaying images of orthogonal polarity, each eye will see slightly different images producing a stereoscopic effect. In the absence of the appropriate glasses, images will appear fuzzy as objects will be displayed simultaneously (or at least virtually simultaneous) in two different positions.

### Active Shutter

This stereoscopic video method sequentially blocks one eye then the other eye. This method utilizes glasses that have an electronic shutter in front of each eye. In sync with the display of stereoscopic video, the shutters are alternately opened and closed such that each eye will see a different image. Because only one eye can see at a time, alternating the image displayed during the period corresponding to each eye can be used to produce a stereoscopic effect. In the absence of the appropriate glasses images will appear to be fuzzy as objects will be displayed in slightly different positions in rapid succession.

### Side-by-Side

The method utilizes the simultaneous display of slightly different images that are spatial separated (i.e., side-by-side). In this 3D mode, each eye will see a slightly different image. For example, if the image is sufficiently close to the viewer's face or some type of blinder is used, each eye is forced to see a slightly different image. Goggles can be used as a simple way of restricting the image viewed by each eye. In the absence of the appropriate viewing mechanism, the image will appear as virtually identical copies of the same image side-by-side.

In addition to its use as a method of presenting stereoscopic video presentations, side-by-side can be used as a transmission format. In such cases, an image having two halves is transmitted with one halve representing the image for the left eye and the other halve representing the image for the right eye. Upon receipt, each half of the image is separated and rescaled to have the same size as the original transmitted image. The two separated images can be combined with other 3D methodologies to produce a stereoscopic effect. Because each transmitted image is only half of a displayed image, the resulting images will have less detail.

### 2D Format

In contrast to the stereoscopic video methods discussed above, the presentation of two-dimensional images requires no special equipment as each eye will see the exact same image. A potential conflict exists when stereoscopic special equipment is used to view two-dimensional video presentations. Although the viewing of stereoscopic video presentation without the use of special equipment may produce undesirable results, the reverse is not necessarily true. With the exception of Anaglyph 3D, the corresponding glasses are generally consistent with normal viewing. In the case of Anaglyph 3D, each eye will see different colors in a manner that may be uncomfortable to a viewer. Because two-dimensional video presentations generally use unpolarized light, using polarized glasses will have little effect because each eye will see the same image albeit without the corresponding alignments of light. Using goggles designed for side-by-side viewing will have little effect as both eyes will view identical images. The viability of using active shutter glasses to view stereoscopic video will depend on the configuration. Provided that the shutters default to being open, the viewing experience will be the same. However, if for technical reasons one shutter must be closed at all times, the opening and closing must still be synchronized with the display of video images or the viewing experience will be degraded

### BRIEF DESCRIPTION OF THE DRAWINGS

FIG. 1 is an example of a server that can be used to implement the disclosed technology.

FIG. 2 is an high level overview of how the disclosed technology might be implemented.

FIG. 3 is a high-level flow chart illustrating one embodiment of the disclosed technology.

FIG. 4 is a flow chart illustrating one embodiment of receiving a request for a stereoscopic video program.

FIG. 5 is a flow chart illustrating one embodiment of streaming a requested stereoscopic video program.

### DETAILED DESCRIPTION

This disclosure can be understood in the context of the following example. However, what follows is merely an example and is not intended to define the scope of this patent, which is defined by the claims. Although, certain functions are described as being performed by various servers, there is no requirement that the described functions be separated in this manner. Functionality described as being performed by one machine may be performed using multiple machines. Similarly, the described functionality can be combined such that less than the number of machines discussed below can be utilized. References to servers include logical servers as well as physical servers. For example, several machines can be combined to function as a single server or a single machine may be configured to operate several servers.

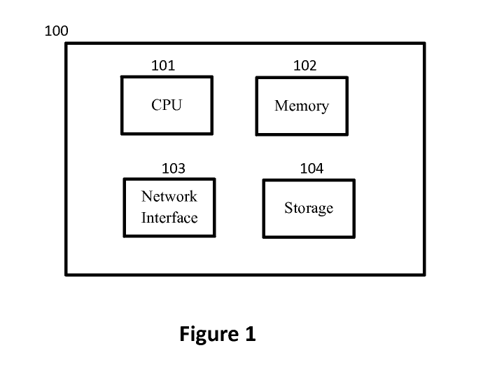

FIG. 1 illustrates an embodiment of server 100. Server 100 illustrated in FIG. 1 contains a central processing unit 101, memory 102, a network interface 103, and storage 104. The storage 104 can comprise any type of persistent storage and may include optical media, magnetic media, and any other nontransient signals. Storage 104 may be comprised of any number, quantity, or configuration of storage types. For example, storage 104 may comprise six drives hard drives (magnetic media) configured in a RAID array, two solid state drives, one CD-ROM drive, one BD-ROM and a tape drive. The components of server 100 may be distributed over several locations as needed by the system implementation.

Server 100 illustrates a machine, however, the term “server” also refers to a program running on a machine. For example, server 100 could be described as running a web server or a ftp server. In such cases, the term “server” may refer to software functionality, the machine providing the software functionality, or both depending on the context. Any such software functionality can be stored on any nontransient computer-readable media such as optical disc, flash drives, or hard drives.

The User Interface Server

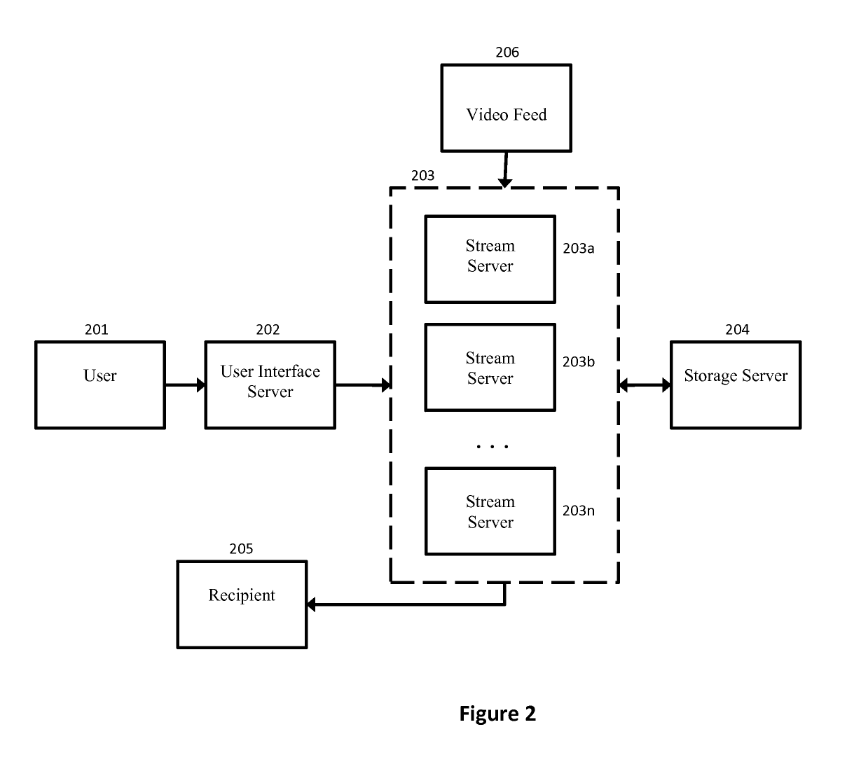

With reference to FIG. 2, the user interface server 202 provides a user interface that enables access to stereoscopic video content. This stereoscopic video content may be live or previously stored. The user interface may be a webpage or embedded in a webpage. As exemplar, the user interface may also be part of a software application, a hardware device, or any combination thereof. In some cases, the user interface may be configured to allow access through external devices. This can be configured as an exclusive access or in addition to direct access by users. The user interface may also be capable of receiving stereoscopic video programs. There are a variety of video platforms for use in the receipt of stereoscopic video that can be accommodated. Some examples include Adobe Flash player, Microsoft Silverlight, Windows Media Player, etc. However, as those of skill will recognize after appreciating this disclosure, the technology is not limited to any particular platform.

Via the user interface server 202, a user 201 can request a stereoscopic video program for display to a recipient 205 that may or may not be at the same location as the user. For example, a central administrator could request video for display at another location such as a conference room or collection of conference rooms. In addition, the user interface server 202 may be located remote from user 201, which initiates a request. For example, if the user interface server 202 is resident on a webserver, users might interact with this technology by communicating with the web browser which initiates a request on behalf of users 201. In such cases, the webserver could be considered to be the user interface server 202. However, a webserver as contemplated by the disclosed technology needn't function in this manner. For example, the webserver might simply facilitate communication by providing users with information that allows them to communicate with the stream server 203 without intervention by the webserver. In such cases, the functionality of user interface server 202 could be on the computer of user 201 or some other computer that is neither the user's computer nor the webserver.

The Stream Server

Among other things, stream server 203 obtains stereoscopic content and provides it to one or more recipients 205. To accommodate the stereoscopic viewing capabilities of each recipient 205, stream server 203 is capable of providing video in a requested format. In addition, the stream server 203 has the capability of presenting stereoscopic video in two-dimensions to recipients 205 that lack the equipment necessary to view stereoscopic video.

Stream servers can receive requests from one or more user interface servers 202 and in response provide stereoscopic video to the user interface server 202 and/or a user 201 or other recipient 205. However, a stream server may provide video automatically at a specified time or in response to another event. In addition to providing stereoscopic video, stream server 203 may also obtain stereoscopic video from one or more storage servers 204. In other cases, stream server 203 may obtain stereoscopic video from a video feed 206. A video feed 206 may be used when a live video program needs to be streamed. The communication between stream server 203 and the one or more storage servers 204 is bidirectional because stream server 203 is capable of streaming a video feed 206 to each storage server 204 for storage and eventual streaming in the future. Stream server 203 may also communicate with, enlist, or create an additional stream server to expand the stream server's ability to perform its functions. In this way, the streaming of stereoscopic video can utilize as many stream servers 203 as desired to provide stereoscopic video.

### Scaling

Additional stream servers 203a, 203b, . . . 203n can be utilized in response to a fixed number of requests per stream server, a maximum bandwidth per stream server, or any other criteria considered useful in distributing streaming capability amongst one or more streaming servers 203a, 203b, . . . 203n. In addition, any such mechanism for using additional stream servers need not be static in that the requirements for utilizing an additional stream server 203a, 203b, . . . 203n may become more stringent as the number of available stream servers 203n decreases. For sake of simplicity, reference will be made to stream server 203 which refers to stream server 203a, 203b, . . . 203n both collectively and individually.

Such additional utilization may be initiated in response to a request for stereoscopic video, a change in the availability of resources, or based on any other relevant criteria such as the occurrence of an event or a predetermined time. Moreover, stream server 203 has the ability to reduce the number of stream servers used in response to the occurrence of events or a predetermined time. For example, as the need for resources is reduced, stream server 203 could assign some of its streaming tasks to other stream servers 203 and if stream server 203 has no more streaming tasks, it might enter a reserve state for later usage.

Stream server 203 may utilize any standard protocol for the distribution of streaming information including for example, the RTMP protocol. Stream server 203 can also utilize multicast technology, where appropriate, to reduce the bandwidth requirements associated with the distribution of stereoscopic video.

### Access Control

Stereoscopic video programs provided by this technology can be limited to certain viewers based on any suitable criteria. For example, receipt of stereoscopic video can be allowed only if a proper username and password is received. Other exemplar forms of authentication can be employed such as digital certificates or biometric data, for example

In addition to or in lieu of authentication measures, receipt of stereoscopic video can also be restricted based on the IP address(es) of the users 201 or recipients 205, the number of requesters, etc. Transmission of stereoscopic video can also be restricted pending receipt of payment or otherwise limited in relation to receipt of compensation. Alternate forms of compensation might include requiring users to view an advertisement prior to viewing the stereoscopic video program. Other examples include limiting access to a certain number of concurrent users or to specific users. Access control can be further modified by adding time restrictions. This technology can adapt to any of a variety of the desired access control mechanism known in the art.

In one exemplar embodiment, the system may store the following information corresponding to a user 201: login name, password, username, e-mail address, status (active, inactive), group(s), birthday, gender. In addition to identifying a particular user, these fields can be used to restrict access or control interaction with a given user. For example, the e-mail address can be used to notify a user of the availability of a particular stereoscopic video or to report problems. The birthday could be used to restrict a program to a certain age group. Fields like username and password are generally used to identify a user and verify the identity of the user. The status field can be used to deactivate a user without removing the entry corresponding to that user. The use of one or more group fields provide the ability to restrict or grant access to certain class of persons, such as allowing access to an engineering group while restricting access to an accounting group.

The above is just one example of the manner in which user information can be used to control access to stereoscopic video programs. Alternate fields or entirely different mechanisms could be employed as those of skill will recognize after appreciating this disclosure. For example, a record could consist entirely of a public certificate with access being granted only to those with the corresponding private key.

Access control employed with the disclosed system may also employ encryption and/or compression. The use of encryption and compression may reduce performance by adding a delay due to the processing necessary to perform these operations. However, in the case of compression, overall performance may be improved by reducing the bandwidth necessary to transport stereoscopic video. The use of encryption reduces the possibility of having a transmission intercepted by unauthorized viewers. This technology can accommodate both compression and encryption if desired by a given application.

Storage Server

Storage server 204 can be used to store stereoscopic video for later distribution. Storage server 204 both provides stored video and allows for the distribution of said video. In one embodiment, a database record is associated with each stereoscopic video presentation that may include the following fields: video name, video description, codec format, creation date (or any other relevant date), keywords, availability status, link to thumbnail image, link to video file, video file extension. The above fields can be used by both the stream server 203 and/or the user interface server 202. Fields such as “video name,” “video description” and “keywords” can be used to find a desired stereoscopic video program. Fields such as “availability status” can be used to restrict access to a stereoscopic video program without regard to authorization. For example, access to a video program can be denied due to maintenance of the file or its corresponding server. Fields that link to a thumbnail image and the video file itself enables separation between the database of stereoscopic video programs and the stereoscopic video programs themselves. In addition, the use of links allows alteration of the location of video files and thumbnail images with relatively minimal changes to the database. Fields such as “codec format” and “extension of the video file” provide information that may be useful in converting a stereoscopic video program into the desired output format. For example, the video file extension may provide information useful in understanding the codec format.

The process of adding new video to storage server may include the following steps:
(1) Video metadata is stored to database on a user interface server and the stereoscopic video program is store on the user interface server.
(2) The user interface server is polled at some interval, every minute for example, to determine if it contains new stereoscopic video program files.
(3) If a new stereoscopic video program file is detected, the file and its corresponding metadata are copied from the user interface server to a storage server.
(4) Once the file has successfully been transferred to the storage server, the file on the user interface server is removed.
   Transfer of files between the user interface server and the storage server can be accomplished by any known means of file transfer including just as examples, ftp, tftp, rynsc, rcp, ssh, etc.

### EXAMPLE

The use of the described technology can be further explained by the following example which is not to be construed as limiting but merely an exemplar.

Stream server 203 is coupled to database of stereoscopic video presentations. The database may be resident on stream server 203, user interface server 202, storage server 204, distributed between these servers, or maintained separately as shown in FIG. 2.

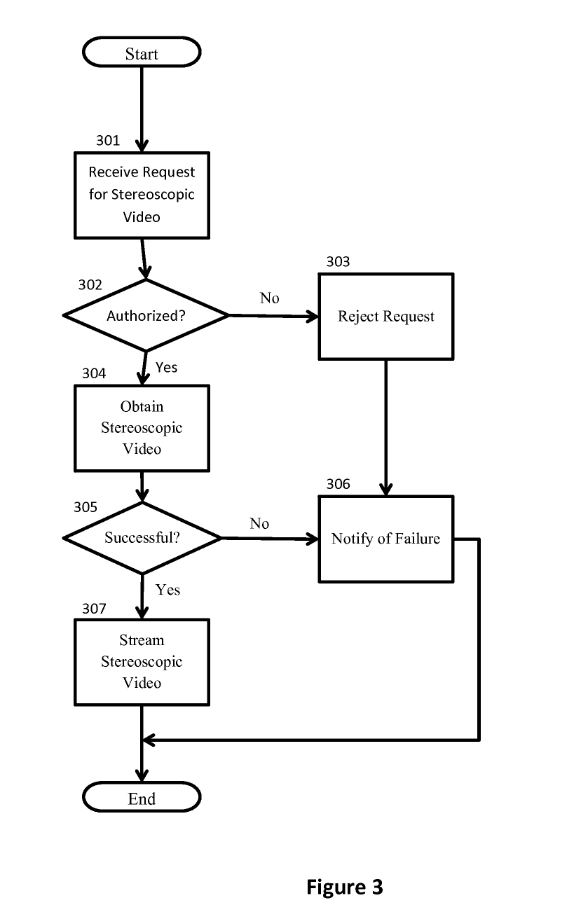

An exemplar flow of this embodiment with respect to each request is illustrated in FIG. 3. At step 301, a request to receive stereoscopic video is received. This step may occur at a user interface server 202 or a stream server 203. After the request is received at step 301, a determination is made at step 302 to determine if the request is an authorized request. If the request is not authorized, the request is rejected at step 303, the user 201 is notified at step 306 and the process ends. If the request is authorized, the stereoscopic video program is obtained at step 304. This process may fail for example, due to hardware failure, network failures, or the stereoscopic video program is designated as unavailable. If step 304 fails for any reason, the user 201 is notified at step 305 and the process ends. If step 304 is successful, the requested stereoscopic video is streamed to the requested recipient 205.

In this embodiment, user interface server 202 includes a web server. Users 201, through their respective web browsers, select a stereoscopic video program and a desired stereoscopic video format. These requests are submitted to the user interface server which communicates with a stream server 203 on behalf of each user 201. The user interface server is capable of serving more than one user simultaneously. This embodiment employs one or more user interface servers that may be allocated in a myriad of ways. For example, a user interface server may correspond to a region or several user interface servers may be configured in a round robin configuration in which a user's request is serviced by the next user interface server in the rotation. For reliability reasons, user interface server 202 can be configured to redirect the request of user 201 to a different user interface server 202 if the given user interface server is overloaded or if warranted by some other condition. In addition to web browsers, users may employ other applications or modules to communicate with the user interface server 202. The user interface server 202 can be configured to use any suitable communication protocol.

In addition to identification of a desired stereoscopic video program and a desired stereoscopic video format, interaction with the user and the user interface server may include various forms of identification, authentication or payment. For example, users may be required to submit a username and password. The user may be required to transmit biometric data such as a fingerprint or voice sample. The user may also be required to submit a digital certificate or other form of electronic signature. In other cases, identification of the user may occur passively such as through use of the requesting IP address of the user or a dynamically assigned serial number. All of the above mechanisms may, but need not, be unique. For example a username and password may be shared amongst a group of users. This is just some of the available modes of authentication adaptable for use with this system and method as would be appreciated by one of skill in the art after appreciating this disclosure.

In addition to possible authentication and identification requirements, user interface server 202 may provide for the collection of payment. User interface server 202 can provide an interface for users to submit credit card, bank or other payment information that can be used to collect funds. Any such payment information can be associated with a corresponding identifier which can in turn be used in determining whether a request for stereoscopic video is authorized. In some cases, for example, the corresponding identifier may be a user number. In other cases where usernames are not used, the identifier might be a browser cookie or a dynamically generated serial number, as examples. User interface server 202 may also interact with an internal accounting mechanism that may track how much money is associated with a particular identifier. If upfront payment is not required, the internal accounting mechanism may be configured to extend credit.

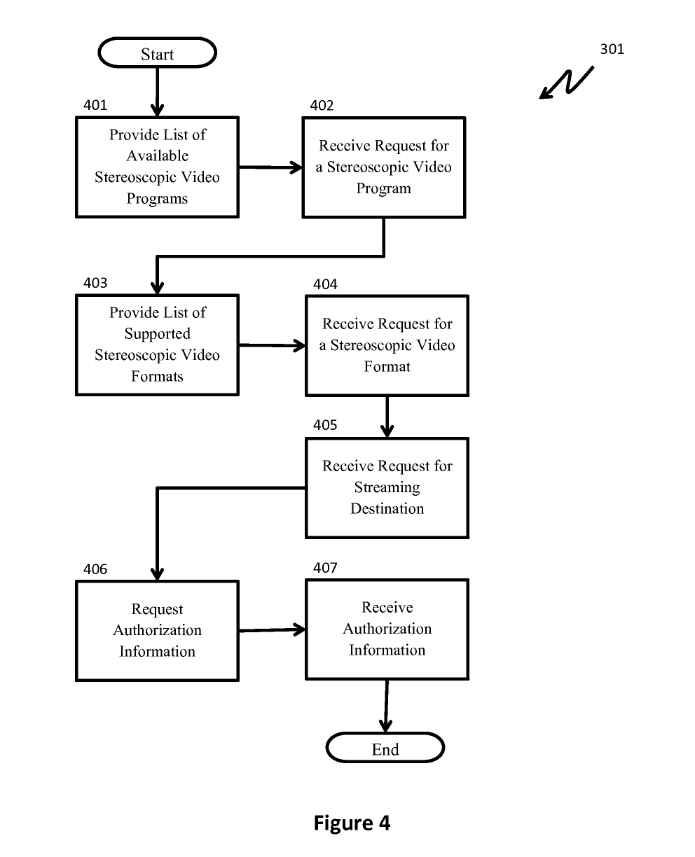

An exemplar process of receiving a request for stereoscopic video is illustrated generally as FIG. 4. In this embodiment, user interface server 202 provides a list of available stereoscopic video programs as step 401. This list may be based on information stored in a database. User 201 selects a desired stereoscopic video and transmits this information to user interface server 202 at step 402. At step 403, user interface server 202 provides a list of supported stereoscopic video formats. From among this list, user 201 selects a desired stereoscopic video format and transmits this information to user interface server 202. At step 405, user interface server 202 receives a requested streaming destination. This destination need not be explicit and may be the IP address that the user 201 uses to communicate with user interface server 202. At step 406, user interface server 202 requests authorization information. This request for authorization information may always seek the same information such as username and password. It may also vary based on the requested stereoscopic video program. In other cases, step 406 may be entirely omitted. Whatever authorization information is requested is received by the user interface server at step 407. FIG. 4 illustrates but one possible flow. For example, authorization may precede identification of a desired stereoscopic video program and stereoscopic video format. Identification of program and format may occur simultaneously.

Based on authentication, identification and/or payment information, user interface server 202 determines if a particular request for a stereoscopic video program is an authorized request. In addition to information corresponding to the user, this determination may include information about the requested stereoscopic video program. For example, certain video programs may have different authorization requirements. In addition, authentication, identification, and payment can be completely disregarded if the requested stereoscopic video program has no authorization requirements. In some embodiments, the collection of authentication, identification, and payment information does not occur until after the user interface server has transmitted a request for the requested stereoscopic video program. The stream server informs the user interface server as to what information is necessary for authorization and the user interface server collects information accordingly. Additionally, the same type of authorization may not apply to an entire stereoscopic video program. For example, a first portion of a stereoscopic video program might require no authorization, but the remaining portion does require authorization. Depending on the manner in which authorization is implemented, the user interface server may transmit information regarding authentication, identification and/or payment to stream server 203 or some other server for an authorization decision. In other embodiments, user interface server 202 makes the authorization determination.

Without regard to authorization, which may occur at any point within the process, the user interface server transmits a request to stream server 203 that includes an identification of the requested stereoscopic video program, the requested stereoscopic video format, and one or more desired recipients 205. The user interface server can request that the stereoscopic video be transmitted directly to one or more users or that the requested stereoscopic video may be transmitted to users via the user interface server or other servers for distribution to corresponding users.

At step 304, stream server 203 utilizes a database to determine the location of the requested stereoscopic video program. Stream server 203 establishes a connection with the location containing the requested video program. In one embodiment, stream server 203 will stream content to itself at approximately the playback rate of the stereoscopic video program. In other embodiments, stream server 203 will create a local copy of the entire stereoscopic video program prior to streaming the video program to a recipient 205. In another embodiment, stream server 203 may stream content to a recipient 205 while obtaining the content at a rate faster than the streaming rate. The stereoscopic video may be resident on stream server 203 or it may be resident on storage server 204 or some other server. The video program may also be stored in multiple full or partial instances in multiple locations. For example, the entire program may be stored in one location, but additional copies of the first half may be stored in several other locations.

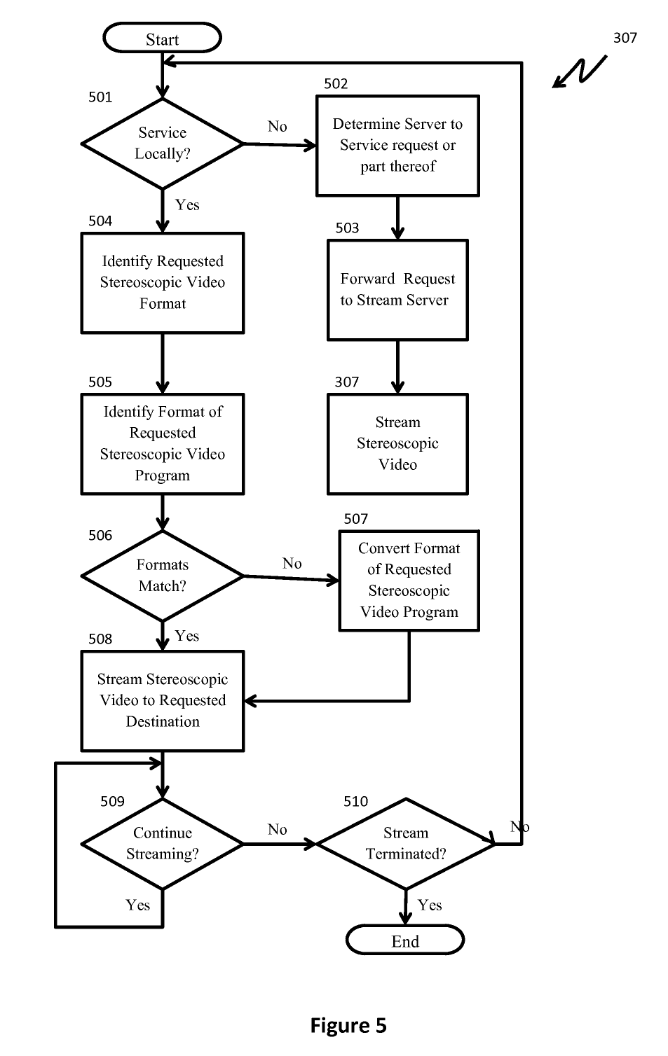

Once step 304 completes successfully, the process of streaming stereoscopic video to the requested recipients is performed as step 307. FIG. 5 illustrates the general flow in streaming video to requested recipients. Assuming an authorized request for stereoscopic video is received, at step 501, stream server 203 determines how much the request, if any, that it should service. This determination is based on the configuration of the particular stream server and may take into consideration factors such as system load, available bandwidth, load of other servers, proximity of the stream server to the recipient or recipients. This determination may also rely on considerations related to the request itself, such as the requested stereoscopic video format or the identity of the specific stereoscopic video program. Although illustrated as a simple “yes” or “no”, the result of step 501 is not necessarily all-or-nothing and could vary between portions of a single request. At step 501, stream server 203 may determine that only a portion of the request should be serviced by another stream server 203.

If the result of step 501 is not an unqualified “yes”, stream server 203 determines which stream server 203 should service the request or a portion thereof at step 502. The request may be serviced by multiple stream servers 203 in various configurations. In one configuration, certain destinations are serviced by one stream server and other destinations are serviced by another stream server. In one configuration, a particular destination may be serviced simultaneously by two different stream servers. For example, if two stream servers contain a copy of the same video program, the first stream server 203 might deliver odd numbered blocks of the video program and the second stream server 203 may deliver even numbered blocks of the video program. Once step 502 is complete, the determination is transmitted to the corresponding stream servers 203 at step 503. The receiving stream server performs step 307 based on the received request. Depending on the configuration, stream server 203 may forward the request or a portion thereof to another stream server 203 even if that requests has been received via forwarding form another stream server 203.

The function of determining how a request should be serviced by steps 501 and 502 may be performed by a dedicated or centralized server that receives and distributes all requests for stereoscopic video to stream servers 203. In such cases, this dedicated server may be configured to bypass step 501 and begin with step 502. Step 502 can take into account the status of an entire network of stream servers 203. Step 502 may involve enlisting additional shared resources or the activation of stream servers that may have been held in reserve. Step 502 may involve routing concurrent requests for the same stereoscopic video program to the same stream server or servers. In some cases, it may be more efficient to assign the request to a stream server that is already in the process of streaming the common requested stereoscopic video program. Stream server 203 is capable of streaming a particular stereoscopic video program synchronously and asynchronously. For example, in the case of a live stereoscopic video program, all viewers will see the same program simultaneously. However, in the case of stored stereoscopic video it is possible, but not required, that different users are viewing different portions of a particular stereoscopic video program. Asynchronous transmission also includes situations in which some viewers are viewing a program live and others that are viewing the same program with a delay.

At step 504, stream server 203 determines the format of the requested stereoscopic video as it will be received by the stream server. At step 505, stream server 203 identifies the requested stereoscopic format. At step 506, the two formats are compared. If they match, stream server 203 begins streaming the requested stereoscopic video program to the requested recipients at step 508 with little if any modification. If step 506 determines that there is a difference between the video format of the requested stereoscopic video and the requested stereoscopic video format, stream server 203 initiates a conversion process at step 507. Stream server 203 decodes the requested stereoscopic video and then encodes this stereoscopic video into the requested stereoscopic video format. In lieu, of decoding and encoding, stream server 203 may also employ a transcoder which converts directly from the stored stereoscopic video format to the requested stereoscopic video format at step 508. Once the stereoscopic video has been converted, if necessary, it is streamed to one or more of the designated recipients using the requested stereoscopic video format.

FIG. 3 is also applicable to internally generated request for stereoscopic video. For example, a video feed could be stored on a storage server via the same mechanism because storage server 204 is a valid recipient 205. This form of internal streaming may occur in the case of recording a live video feeds. It may also be used to transfer stereoscopic video between storage servers or used as a cache. Caching stereoscopic video in this manner may reduce the use of resources in subsequent requests for the same stereoscopic video program.

At step 509, a determination is made whether to continue streaming using the present configuration of stream servers 203. If the present configuration is to be retained, this step is repeated until this is no longer true. As a practical matter, step 509 will not occur continuously. For example, a determination might occur every ten minutes or it may occur after each quarter of the program has been streamed. Additionally, this determination can be subject to events that are not predetermined such as direct control by another device. Once the streaming configuration is to be changed for whatever reason, the stream is checked for termination. If the stream has completed or has been cancelled for whatever reason the request and delivery of the particular stereoscopic video program has been completed. Otherwise, the allocation of resources for servicing the request is reevaluated. Based on repeating steps 501 and 502, the allocation of stream server resources may be altered. This may occur if there is a decrease in the number of users, or additional resources are needed for higher priority programs. As with the initial allocation of resources, this reallocation of resources in steps 501 and 502 can be performed by a dedicated or centralized server.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A computer-implemented method comprising the steps of:
receiving a first request for a first requested stereoscopic video, wherein the first request includes identification of a first requested stereoscopic video format;
obtaining the first requested stereoscopic video, wherein said first requested stereoscopic video is encoded in an initial stereoscopic video format;
converting the first requested stereoscopic video from the initial stereoscopic video format into the first requested stereoscopic video format to produce first converted stereoscopic video; and
transmitting the first converted stereoscopic video to one or more recipients.

2. The method of claim 2, further comprising the steps of:
receiving a second request for the first requested stereoscopic video, wherein the second request includes identification of a second requested stereoscope video format;
converting the stereoscopic video from the initial stereoscopic video format into the second requested stereoscopic video format to produce second converted stereoscopic video; and
transmitting the second converted stereoscopic video to one or more recipients.

3. The method of claim 2, wherein the first requested stereoscopic video format is not the same as the second requested stereoscopic video format.

4. The method of claim 1, wherein the step of transmitting the first converted stereoscopic video to one more recipients comprises transmitting the first converted stereoscopic video from one or more stereoscopic video distribution systems.

5. The method of claim 4, wherein an additional stereoscopic video distribution system is utilized in response to receiving a request for stereoscopic video.

6. The method of claim 1, wherein the step of receiving a first request for first requested stereoscopic video, comprises receiving the first request at a first video server.

7. The method of claim 6, wherein the step of transmitting the first converted stereoscopic video comprises transmitting the first converted stereoscopic video from one or more stereoscopic video distribution systems.

8. The method of claim 7, wherein an additional stereoscopic video distribution system is utilized in response to receiving a request for stereoscopic video.

9. The method of claim 1, wherein the first request for first requested stereoscopic video utilizes a webpage interface.

10. The method of claim 1, wherein the step of transmitting the first converted stereoscopic video to one or more viewers comprises transmitting the first converted stereoscopic video to one or more viewers via a webpage interface.

11. The method of claim 1, further comprising:
receiving first authentication information associated with the first request for first requested stereoscopic video
obtaining first authorization information associated with the first requested stereoscopic video
evaluating the first authentication information and the first authorization information to determine if the first request for first requested stereoscopic video is an authorized request for the first requested stereoscopic video

12. The method of claim 1, wherein the step of obtaining the first requested stereoscopic video occurs prior to the step of receiving a first request for first requested stereoscopic video

13. The method of claim 1, wherein the first requested stereoscopic video is a live presentation.

14. The method of claim 1, wherein the step of transmitting the first converted stereoscopic video to one or more viewers utilizes the RTMP protocol.

15. A computer-implemented method comprising the steps of:
receiving a request for stereoscopic video, wherein the request includes identification of a requested stereoscopic video format and requested recipients;
making a first determination of computing resources to be used to service the request for stereoscopic video;
using the first determined resources, obtaining the first requested stereoscopic video using the determined resources, wherein said requested stereoscopic video is encoded in an initial stereoscopic video format;
using the first determined resources, converting the requested stereoscopic video from the initial stereoscopic video format into the requested stereoscopic video format to produce converted stereoscopic video; and
using the first determined resources, streaming the converted stereoscopic video to the requested recipients.

16. The method of claim 15, further comprising:
authorizing the streaming of converted stereoscopic video to the requested recipients.

17. The method of claim 16, wherein the step of authorizing the transmission mission of converted stereoscopic video to the requested recipients occurs prior to the step of receiving a request for stereoscopic video.

18. The method of claim 15, further comprising the steps of:
during streaming of the converted stereoscopic video, making a second determination of computing resources to be used to service the request for stereoscopic video;
using the second determined resources, obtaining the first requested stereoscopic video using the determined resources, wherein said requested stereoscopic video is encoded in an initial stereoscopic video format;
using the second determined resources, converting the requested stereoscopic video from the initial stereoscopic video format into the requested stereoscopic video format to produce converted stereoscopic video; and
using the second determined resources, streaming the converted stereoscopic video to the requested recipients.

19. The method of claim 15, wherein there are a plurality of recipients and each recipient is serviced by non-identical resources.

20. The method of claim 15, wherein the streaming uses the RTMP protocol.

21. The method of claim 18, wherein the first determined resources and the second determined resources are the same.

22. The method of claim 18, wherein the second determined resources includes some of the computing resources within the first determined resources.

23. A system comprising:
a user interface server configured to interact with users and provide for the requesting of stereoscopic video for streaming to one or more recipients.
a stream server configured to receive requests for stereoscopic video and stream the requested stereoscopic video to the one or more recipients; and
a storage server configured to store and stereoscopic video and provide stereoscopic video upon request.

24. The system of claim 23, wherein the user interface server, the system server, and the storage server are the same machine.

25. The system of claim 23, wherein the system server comprises multiple machines.

26. The system of claim 23, wherein the system is configured to perform the steps of:
receiving a request for stereoscopic video, wherein the request includes identification of a requested stereoscopic video format and requested recipients;
making a first determination of computing resources to be used to service the request for stereoscopic video;
using the first determined resources, obtaining the first requested stereoscopic video using the determined resources, wherein said requested stereoscopic video is encoded in an initial stereoscopic video format;
using the first determined resources, converting the requested stereoscopic video from the initial stereoscopic video format into the requested stereoscopic video format to produce converted stereoscopic video; and
using the first determined resources, streaming the converted stereoscopic video to the requested recipients.

27. The system of claim 23, wherein the system is further configured to perform the steps of:
while streaming converted stereoscopic video, making a second determination of computing resources to be used to service the request for stereoscopic video;
using the second determined resources, obtaining the first requested stereoscopic video using the determined resources, wherein said requested stereoscopic video is encoded in an initial stereoscopic video format;
using the second determined resources, converting the requested stereoscopic video from the initial stereoscopic video format into the requested stereoscopic video format to produce converted stereoscopic video; and
using the second determined resources, streaming the converted stereoscopic video to the requested recipients.

28. Nontransient computer-readable media containing instructions that when performed by one or more computers will enable the one or more computers to perform the steps of:
receiving a request for stereoscopic video, wherein the request includes identification of a requested stereoscopic video format and requested recipients;
making a first determination of computing resources to be used to service the request for stereoscopic video;
using the first determined resources, obtaining the first requested stereoscopic video using the determined resources, wherein said requested stereoscopic video is encoded in an initial stereoscopic video format;
using the first determined resources, converting the requested stereoscopic video from the initial stereoscopic video format into the requested stereoscopic video format to produce converted stereoscopic video; and
using the first determined resources, streaming the converted stereoscopic video to the requested recipients.

29. The nontransient computer-readable media of claim 28 further containing instructions that when performed by one or more computers will enable these computers to perform the additional steps of:
during streaming of the converted stereoscopic video, making a second determination of computing resources to be used to service the request for stereoscopic video;
using the second determined resources, obtaining the first requested stereoscopic video using the determined resources, wherein said requested stereoscopic video is encoded in an initial stereoscopic video format;
using the second determined resources, converting the requested stereoscopic video from the initial stereoscopic video format into the requested stereoscopic video format to produce converted stereoscopic video; and
using the second determined resources, streaming the converted stereoscopic video to the requested recipients.
